(19) United States
(12) Patent Application Publication
(10) Pub. No.: US 2016/0232482 A1
(43) Pub. Date: Aug. 11, 2016

(54) METHOD AND SYSTEM FOR ENTERPRISE MARKETPLACE INCLUDING NOTIFICATION SERVICES

(71) Applicant: Oracle International Corporation, Redwood Shores, CA (US)

(72) Inventors: Girish Anantharaju, San Jose, CA (US); Nigel King, San Mateo, CA (US)

(21) Appl. No.: 14/614,755

(22) Filed: Feb. 5, 2015

(51) Int. Cl. G06Q 10/08; G06Q 30/06

(52) U.S. Cl. CPC G06Q 10/0833; G06Q 30/0639

(57) ABSTRACT

A system and method for facilitating enterprise gift giving via an enterprise marketplace for notification services. An example method includes determining that a condition has been met for delivery of one or more gifts to one or more intended gift recipients; accessing recipient information; ascertaining merchant information; and employing recipient information and the merchant information to automatically initiate delivery of the one or more gifts to the one or more intended recipients in response to the determining. In a more specific embodiment, the method is implemented in part by an integrated enterprise application that triggers automatic dispatch and delivery of electronic and/or physical gifts from pre-approved merchants to recipients when certain workflow events are detected in accordance with a configuration associated with an enterprise workflow monitored by the integrated enterprise application.

### BACKGROUND

The present application relates to computing, and more specifically to software and accompanying systems and methods for providing and using electronic marketplaces.

Electronic marketplaces are employed in various demanding applications, including online auctions, merchant websites, stock exchanges, and so on. Such applications often demand efficient systems for facilitating transfer of goods and/or services, including selection of and delivery of gifts, such as electronic gifts (e.g., gift card numbers, electronic subscriptions to services or content, etc.).

Efficient mechanisms for facilitating gift selection and delivery can be particularly important in large enterprise environments, where an enterprise may wish to give gifts to thousands of customers and/or other enterprise-related personnel for various types of activities.

Conventionally, when an enterprise or representative thereof (also called the gift giver) decides to give a gift to a customer, employee, contractor, website registrant, etc., the gift giver must often get approval for sending the gift; must select the gift; must pay for the gift; and must follow up to ensure that the intended recipient has received the gift.

Such steps can be prohibitively inefficient, time consuming, costly, or otherwise problematic. For example, in a particular scenario, an enterprise may choose before third party (e.g., merchant) to provide a gift card to a new registrant to an enterprise website service. However, the third party gift card website may not deliver the gift with branding attributable to the enterprise giving the gift.

Accordingly, the gift recipient may not know who issued the gift. This may require that the enterprise follow up with customer to ensure that the gift is attributed to the enterprise, and/or may require the enterprise and/or gift card merchant to manually review and edit the email (e.g., to add branding, input digital codes, and so on) used to transfer the gift. This can be tedious, error prone, and costly.

### SUMMARY

An example method for facilitating selection and delivery of one or more gifts in an enterprise computing environment via a gift market marketplace includes determining that a condition has been met for delivery of one or more gifts to one or more intended gift recipients; accessing recipient information pertaining to the one or more intended gift recipients; ascertaining merchant information pertaining to one or more merchants that may produce the one or more gifts; and employing recipient information and the merchant information to automatically initiate delivery of the one or more gifts to the one or more intended recipients in response to the determining.

In a more specific embodiment, the information pertaining to the one or more intended recipients includes delivery destination information, such as an electronic address (e.g., email address or phone number for delivery of a text message) or physical address. The merchant information may include location information pertaining to a physical address of one or more merchants who have been pre-approved by the enterprise for gift delivery.

In the specific example embodiment, the condition includes occurrence of an event occurring as part of a predetermined enterprise work flow. The event may include, for example, enterprise customer registration for a website or service, enterprise partner registration, an employee reaching a particular milestone or achievement warranting receipt of a gift, and so on. One or more notification services may facilitate notifying enterprise customers or other gift recipients of a gift to be given by the enterprise.

The example method may further include providing an option for an administrator to configure the workflow by specifying one or more gifts to be associated with the work flow. The step of determining may further include monitoring one or more enterprise applications to detect one or more events that meet the condition that warrant delivery of one or more gifts. The one or more enterprise applications include one or more Enterprise Resource Planning (ERP) applications, e.g., a Human Capital Management (HCM) application, a Customer Relationship Management (CRM) application, and so on.

The employing step may further include determining of a gift to be issued is an electronic gift or a physical gift. If the gift is an electronic gift (also called digital gift), then the electronic gift (e.g., thank you letter, gift card number, etc.) is delivered in near real time to one or more recipients. If the gift is a physical gift, then a merchant may be automatically selected to facilitate delivery of the physical gift to a recipient, where the automatic selection may be based on a location of the merchant and a location of the recipient.

If a merchant for delivering a physical gift is not within a predetermined distance of the recipient, then software may automatically select an alternative electronic gift to be delivered to the recipient in place of the physical gift.

In certain implementations, the detected condition may be applicable to a group of intended gift recipients. In such cases, batch processing may be employed to automatically simultaneously initiate delivery of one or more gifts to the intended recipients in accordance with recipient information, gift information, and merchant information. Some recipients may receive digital gifts while others may receive physical gifts depending upon the configuration of the workflow that resulted in detecting the event that meets the condition.

Hence, certain embodiments discussed herein are adapted to enable detection events occurring within or associated with enterprise applications (e.g., ERP, CRM, HCM, etc.) that may warrant automatic fast and efficient issuance of electronic and/or physical gifts to an individual or group of individuals or entities. Electronic gifts may be delivered worldwide in near real time.

Embodiments may be implemented in part by an integrated gift marketplace application, which is integrated with or otherwise in communication with enterprise applications. The marketplace application may interface with a database that maintains pre-approved merchant information. Use of a pre-approved merchant list and accompanying system that may automatically select merchants based on location information (or geographical information), products or services offered, and/or other attributes may further enhance enterprise gift given efficiency.

A further understanding of the nature and the advantages of particular embodiments disclosed herein may be realized by reference of the remaining portions of the specification and the attached drawings.

### BRIEF DESCRIPTION OF THE DRAWINGS

FIG. 1 illustrates a first example system and accompanying enterprise computing environment adapted for use with an electronic gift marketplace.

FIG. 2 illustrates a first example User Interface (UI) display screen for facilitating merchant product registration with the marketplace database of the system of FIG. 1.

FIG. 3 illustrates a second example UI display screen representing an example electronic gift (or notification thereof) delivered via the system of FIG. 1 to a recipient.

FIG. 4 illustrates a first example process involving gift selection and delivery implementable via the system of FIG. 3.

FIG. 5 illustrates a first example event-driven workflow involving delivery of a digital gift to an enterprise employee who has achieved a particular milestone.

FIG. 6 illustrates a second example event-driven workflow involving delivery of a gift to a newly registered enterprise customer or partner as a reward for registering with the enterprise.

FIG. 7 is a flow diagram of a first example method adapted for use with the embodiments of FIGS. 1-6.

FIG. 8 is a flow diagram of a second example method adapted for use with the embodiments of FIGS. 1-7.

### DETAILED DESCRIPTION OF EMBODIMENTS

For the purposes of the present discussion, an enterprise may be any organization of persons, such as a business, university, government, military, and so on. The terms “organization” and “enterprise” are employed interchangeably herein. A talent management system or application may be any software application or functionality for facilitating selecting, organizing, or managing enterprise personnel or tasks performed thereby. Personnel of an organization may include any persons associated with the organization, such as employees, contractors, board members, and so on.

An enterprise computing environment may be any collection of computing resources of an organization used to perform one or more tasks involving computer processing. An example enterprise computing environment includes various computing resources distributed across a network and may further include private and shared content on Intranet Web servers, databases, files on local hard discs or file servers, email systems, document management systems, portals, and so on.

Enterprise software may be any set of computer code that is adapted to facilitate implementing any enterprise-related process or operation, such as managing enterprise resources, managing customer relations, and so on. Example resources include Human Resources (HR) (e.g., enterprise personnel), financial resources, assets, employees, business contacts, sales data, and so on, of an enterprise. Examples of enterprise software include Enterprise Resource Planning (ERP) software for facilitating managing enterprise activities (e.g., product planning, inventory management, marketing, sales, and so on). Example ERP applications include Customer Relationship Management (CRM), Human Capital Management (HCM), Business Intelligence (BI), enterprise asset management, enterprise asset management, corporate performance and governance applications, and so on.

The terms “enterprise software” and “enterprise application” may be employed interchangeably herein. However, an enterprise application may include one or more enterprise software modules or components, such as User Interface (UI) software modules or components.

Enterprise data may be any information pertaining to an organization or business, including information about customers, appointments, meetings, opportunities, customer interactions, projects, tasks, resources, orders, enterprise personnel, and so on. Examples of enterprise data include work-related notes, appointment data, customer contact information, descriptions of work orders, asset descriptions, photographs, contact information, calendar information, enterprise hierarchy information (e.g., corporate organizational chart information), and so on.

For clarity, certain well-known components, such as hard drives, processors, operating systems, power supplies, routers, Internet Service Providers (ISPs), identity management systems, workflow orchestrators, Tenant Automation Systems (TASs), certain web services, Application Programming Interfaces (APIs), and so on, are not necessarily explicitly called out in the figures. However, those skilled in the art with access to the present teachings will know which components to implement and how to implement them to meet the needs of a given implementation.

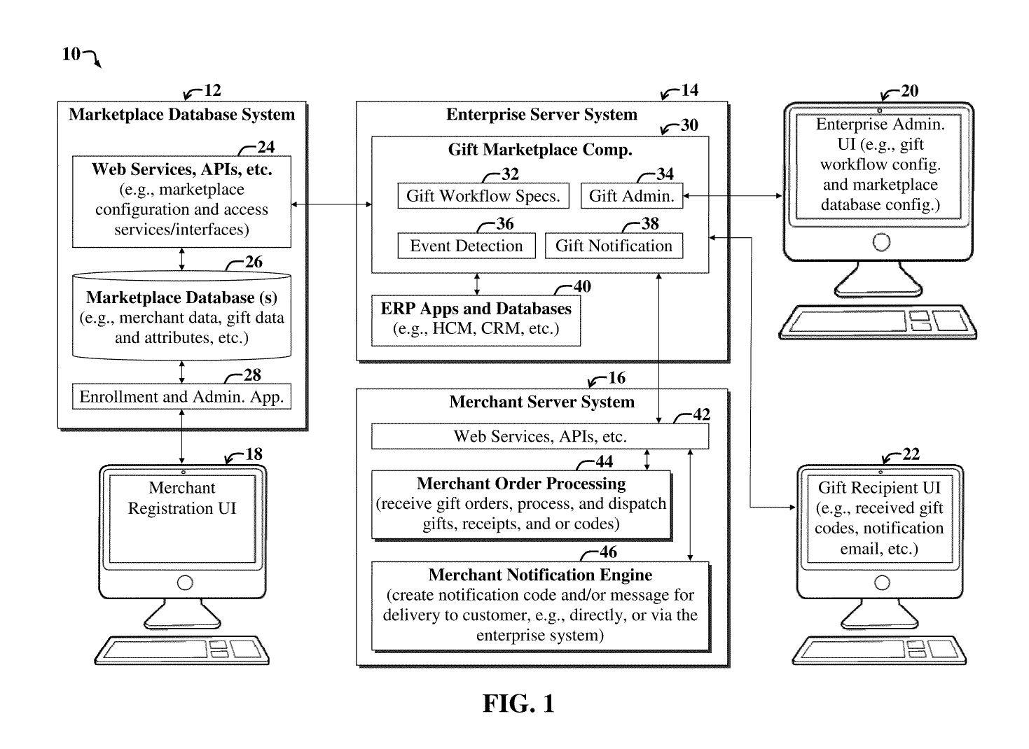

FIG. 1 illustrates a first example system 10 and accompanying enterprise computing environment adapted for use with an electronic gift marketplace represented by a marketplace database system 12. The overall system 10 includes the market database system 12 in communication with an enterprise server system 14 via a network, such as the Internet. The enterprise server system 14 further communicates with a merchant server system 16 via a network, such as the Internet.

Note that, in general, groupings of various modules of the system 10 are illustrative and may vary, e.g., certain modules may be combined with other modules or implemented inside of other modules, or the modules may otherwise be distributed differently among a network or within one or more computing devices, without departing from the scope of the present teachings.

For the purposes of the present discussion, a server system may be any collection of one or more servers. A server may be any computing resource, such as a computer and/or software that is adapted to provide content, e.g., data and/or functionality, to another computing resource or entity that requests it, i.e., the client. A client may be any computer or system that is adapted to receive content from another computer or system, called a server. A Service Oriented Architecture (SOA) server may be any server that is adapted to facilitate providing services accessible to one or more client computers coupled to a network.

A networked computing environment may be any computing environment that includes intercommunicating computers, i.e., a computer network. Similarly, a networked software application may be computer code that is adapted to facilitate communicating with or otherwise using one or more computing resources, e.g., servers, via a network.

A networked software application may be any software application or computer code adapted to use data and/or functionality provided via one or more resources, e.g., data, memory, software functionality, etc., accessible to the software application via a network.

The example enterprise server system 14 includes various ERP applications and databases 40, e.g., HCM, CRM, BI, and so on, in communication with an integrated gift marketplace component 30. Those skilled in the art will appreciate that web services or other interfaces may be employed to facilitate communications between the gift marketplace component 30 and the ERP applications and databases 40.

For the purposes of the present discussion, a web service may be a collection of computer code that is adapted to implement a method for communicating between electronic devices or resources over a network, thereby facilitating interoperable machine-to-machine interaction over a network.

The gift marketplace component 30 includes computer code for monitoring activities of the ERP applications and databases 40 for certain predetermined events that may warrant issuance of a gift to an entity or person associated with the enterprise acting as the proprietor of the enterprise server system 14. The certain predetermined events may be configured via an administrator using an administrator User Interface (UI) system 20 to access the gift marketplace component 30. Detection of one or more of the predetermined events, i.e., conditions being met, triggers implementation of a gift workflow, i.e., process, as discussed more fully below.

For the purposes of the present a gift may be any item or thing of value that is received by a recipient. A gift could also include any item provided as additional to what was ordered as part of a customer-enterprise transaction.

A marketplace may be any mechanism adapted to facilitate exchange of one or more goods and/or services. An electronic marketplace may be any electronic mechanism that provides one or more user options to effect transfer of one or more goods and/or services, e.g., as may be implemented via software running on a server and accessible to one or more client devices of users and/or merchants. The terms “electronic marketplace” and “digital marketplace” used interchangeably.

A merchant may be any entity that employs a marketplace to facilitate offering one or more goods and/or services to another entity, such as to a recipient of a product and/or service.

A gift exchange may be a type of marketplace whereby three primary entities are involved in a transaction, and in particular, a first entity (e.g., enterprise or other gift giver) offering a gift, a second entity to receive the gift (recipient), and a third entity (e.g., merchant) to provide the gift. The first entity may (or may not) pay or otherwise transfer a thing or measurement of value to (e.g., money) the third entity to motivate or otherwise facilitate effecting transfer of another thing of value (i.e., gift) to the second entity. The second entity, i.e., recipient, of a gift typically receives some net value in the exchange between the third entity, i.e., merchant, and the recipient.

The example gift marketplace component 30 includes workflow specifications 32, a gift administrator module 34, an event detection module 36, and a gift notification module 38. The gift administrator module 34 may include computer code for facilitating rendering and implementing UI components and features of a UI of the enterprise administrator system 20. The gift event detection module 36 may include computer code for monitoring enterprise events occurring via ERP applications and databases 40 and determining when a detected event meets a condition or criteria for implementing a gift-giving workflow.

The gift workflow specifications 32 may include specifications of administrator configured workflows, gifts to be associated with certain workflows, events that will trigger certain workflows, and so on, as discussed more fully below. For the purposes of the present discussion, a workflow may be any process that includes one or more business related steps or activities.

The gift notification module 38 is adapted to work in accordance with the gift workflow specifications 32 to issue gift notifications, e.g., notifying gift recipients (also called end users herein) of received digital gifts or physical gifts. In certain implementations, the gift notification module 38 may forward digital gifts and/or gift notifications to appropriate applications included in the ERP applications and databases 40, such as email applications, social network blogs, enterprise chat clients, and so on.

For example, in certain scenarios, the system 10 and accompanying gift workflow specifications 32 will trigger issuance of one or more gifts to one or more enterprise personnel of the proprietor of the system 10. The enterprise personnel may employ a gift recipient UI system 22 to access electronic gifts and notifications.

Alternatively, the gift recipient UI 22 is a smartphone, tablet, or other device, and the gift notification module 38 is adapted to deliver an electronic gift or notification as a text message, e.g., Short Message Service (SMS), or email to a different email server that is not necessarily a part of the ERP applications and databases 40.

For the purposes of the present discussion, enterprise personnel may be any person associated with an enterprise. An enterprise may be any organization of persons, such as a company, non-profit organization, university, government, and so on. Examples of enterprise personnel include employees, independent contractors, managers, investors, and so on.

A recipient may be one or more persons and/or entities (e.g., customers or end users) to receive an item (electronic or physical) and/or who has already received an item. For example, a customer or person who has registered with a website of a particular enterprise may be selected by the enterprise to be a recipient of a gift to be issued to the registrant for their registration.

An electronic message may be any message adapted to be sent via a communications network. Examples of communications networks include packet-switched networks, such as the Internet, circuit-switched networks, such as the Public Switched Telephone Network (PSTN), and wireless networks, such as a Code Division Multiple Access (CDMA), Global System for Mobile communications (GSM), Analog Mobile Phone System (AMPS), Time Division Multiple Access (TDMA) or other network. Hence, a telephone call, teleconference, web conference, video conference, a text message exchange, and so on, fall within the scope of the definition of an electronic message.

An email may be a specific type of electronic message adapted to be sent via Simple Mail Transfer Protocol (SMPT), Internet Message Access Protocol (IMAP), and/or other email protocol. A chat message may be any electronic message adapted to be sent via an interface capable of indicating when another user is online or otherwise available to accept messages.

A text message may be any message that includes text and that is sent via a wireless network or other telephone network, including circuit switched and/or packet switched networks used to make telephone calls. Examples of text messages include Short Message Service (SMS) messages and MultiMedia Service (MMS) messages.

In the present example embodiment, the gift notification module 38 is adapted to receive gift code information and/or other information pertaining to merchandise associated with the gift given to a recipient. The information may come from the merchant server system 16, as may be the case with certain electronic gifts (e.g., gift cards, thank you notes, etc.) and/or physical gifts (wherein the notification may include a receipt or pick-up code, etc.). In other scenarios, certain digital gifts (also called electronic gifts) are generated internally by the enterprise server system 14 (e.g., via the gift marketplace component 30) without requiring use of the merchant server system 16 and associated order processing modules. Accordingly, the gift marketplace component 30 running on the enterprise server system 14 may access the merchant server system 16 on an as needed basis.

The gift marketplace component 30 communicates with the remote marketplace database system 12 via one or more web services and/or APIs 24 thereof and in accordance with a given gift workflow being implemented.

The market database system 12 further includes one or more marketplace databases 26, which may store or otherwise maintain merchant data (including attributes, e.g., geographical attributes), gift data (e.g., whether a gift is electronic or physical, gift availability in different geographies, etc.), and other attributes. The marketplace database 26 may include data organized by merchant, where a merchant may control and specify which products and/or services (digital or otherwise) are offered by the merchant and additional attributes, such as merchandise price, geographic availability, and so on.

A merchant enrollment application 28 may be adapted to provide a merchant registration UI system 18 with both registration functionality and administrative functionality for specifying products and/or services that are available as gifts for use with the system 10. The merchant enrollment application 28 may include web services and/or APIs for facilitating merchant access to the marketplace database 26.

For the purposes of the present discussion, a UI may be any collection of hardware and/or software adapted to facilitate illustrating data and/or providing access to software functionality associated with the UI.

A software UI may be any collection of one or more user interface display screens associated with software. A user interface display screen may be any software-generated depiction presented on a display. Examples of depictions include windows, dialog boxes, displayed tables, and any other graphical user interface features, such as user interface controls, presented to a user via software, such as a browser.

A UI display screen contained within a single border is called a view or window. Views or windows may include sections, such as sub-views or sub-windows, dialog boxes, graphs, tables, and so on. In certain cases, a user interface display screen may refer to all application windows presently displayed on a display.

In an example scenario, an event occurs warranting issuance of one or more gifts to all registrants to an enterprise website with the past month. The event is detected by the event detection module 36 in accordance with predetermined gift workflow specifications 32, as established by an administrator employing the enterprise administration UI 20 in communication with the server-side gift administration module 34.

The gift marketplace component 30 then access the marketplace database system 12 via the web services and/or APIs 24 thereof to determine gift availability, price, etc., and merchant information associated with gifts to be given in accordance with the associated workflow.

The gift marketplace component 30 then determines which gifts to dispatch to which recipients in accordance with the information. For example, if flowers are to be issued as a gift, certain recipients who are not near an available flower shop may be issued equivalently priced digital gifts instead. Algorithms for computing gift issuance based on geography or other attributes and/or criteria may be implemented via the gift marketplace component 30.

After gifts are determined, orders may be forwarded to the merchant server system 16 via the gift marketplace component 30 and web services and/or APIs of the merchant server system 16. A merchant order processing module 44 may receive the orders, process the orders, dispatch gifts (e.g., initiate flower delivery), generate receipts or codes, and so on. The merchant notification engine 46 may generate notification messages with codes or electronic gifts to be delivered to a recipient.

The delivery of electronic gifts and/or receipts for physical gifts may be delivered to a user of the gift recipient UI 22 via the enterprise server system 14 or directly to a separate email server, smartphone telephone number, etc., associated with the recipient. User contact information (e.g., email address) may be accessible to the system 10 via user profile information maintained via the ERP applications and databases 40.

Note that conventionally, when enterprise customers were sent notifications, e.g., thank you notes, e.g., after enrolling in a service, completing a survey, etc., relatively tedious processes were required. Implementations of the system 10 facilitate providing integrated gifting options, where the gifting options and processes are integrated into enterprise application workflows to provide seamless user experiences.

Conventionally, prior to issuing a gift, an enterprise gift giver was often required to go through a merchant approval process to vet or analyze different merchants and collect information about each merchant, e.g., whether the merchant provided products available across different geographies, and so on. For the purposes of the present discussion, location information may be any geographical information, i.e., information characterizing or identifying a location or vicinity of an entity, person, or thing.

Such inefficiencies may be overcome via embodiments implemented in accordance with the system 10 of FIG. 1, whereby participating merchants are pre-approved by the enterprise using the system 10, e.g., via the merchant enrollment 28 in combination with the gift administrator module 34 of the gift marketplace component 30.

For example, an administrator working with the enterprise administrator system 20 may log into the system 14 and then employ the gift marketplace component to access the marketplace database 26 via the web services and APIs 24 thereof. The administrator may then shortlist or otherwise create collections of information pertaining to approved merchandise (digital or otherwise) and vendors that will be accessible to the gift marketplace component 30 for the purposes of issuing gifts.

Hence, certain embodiments discussed herein provide mechanisms and methods for enabling an enterprise marketplace (for digital and physical gifts), wherein the vendors (also called merchants herein) are pre-approved and have been through an internal procurement process for respective geographical regions.

Furthermore, email messages and text messages may be sent either manually (e.g., through one or more templates that may be implemented via the gift notification module 38 of the gift marketplace component 30) or through automated workflows from one or more enterprise applications 40.

Gifts can readily be sent in bulk and batch processed and/or sent individually. For example, if a workflow is configured to send $50 worth of flowers for all new customers registering for a service, then the gift marketplace component 30 may automatically pick a flow merchant present in a geographical region of a recipient (also called end user) and initiate a flower delivery therefrom to the recipient.

Having a pre-approved vendor list and a system that can geographically pick the merchants for a pre-defined geographic location may significantly improve recipient satisfaction, since merchants are already pre-approved, and gift delivery is rapid. Digital gifts, i.e., electronic gifts are delivered in near real time.

For the purposes of the present discussion, “near real time” may refer to any time that is substantially determined by computing environment resources, such as, such as communication bandwidth, processing speed, and so on, and not necessarily delayed by human involvement. For example, an email, after being sent, is said to be delivered to an email recipient in near real time after the email is sent.

The marketplace database system 12, which may represent a database of merchants that have been pre-selected for delivery of gifts, e.g., digital gift cards, physical gifts, etc. The merchant enrollment application 28 may implement a system for merchant enrollment, such that merchants wishing to participate can register and so through enterprise approval processes implemented via the merchant enrollment application 28.

One or more notification templates may be accessible to an enterprise gift giver or administrator, e.g., via computer code of the gift notification module 38. For example, an enterprise administrator may choose merchandise to be given and may assign a workflow. In such case, the administrator need not choose an individual merchant, but may pick the end product to be sent.

When a user of the enterprise software 40 encounters the specified workflow, then at run time, the notification engine 38 may receive information (e.g., from the marketplace database system 12) pertaining to an available merchant for the specified geographical location of the user (to be a gift recipient).

For digital gift codes, the gift marketplace component 30 may make one or more backend web service calls to retrieve gift code information and to create a notification email and/or text message to be sent to the recipient. Similarly, for physical goods, a web service call/notification may be sent to the merchant, e.g., via the merchant server system 16, to deliver the gift to the gift recipient's address.

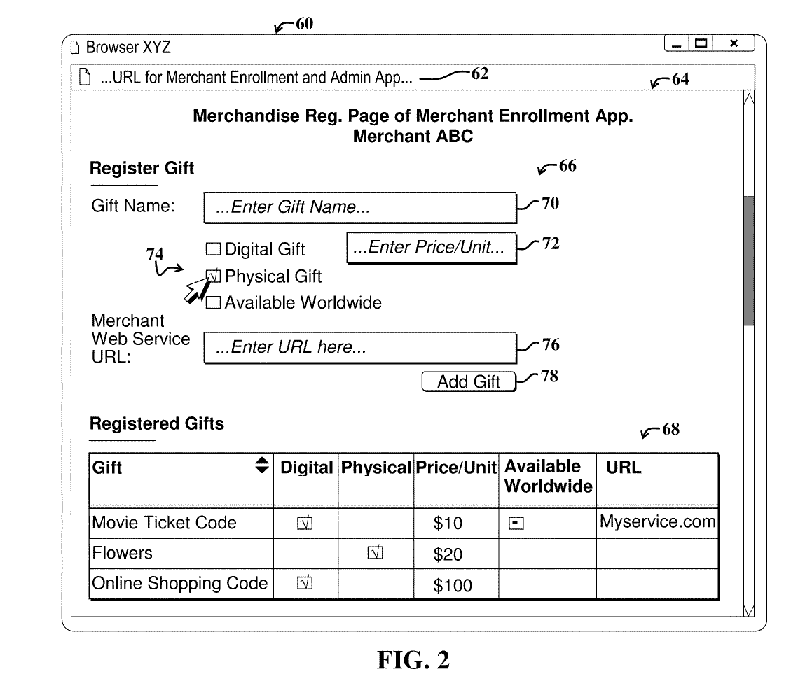

FIG. 2 illustrates a first example User Interface (UI) display screen 60 with features 66-78 for facilitating merchant product registration with the marketplace database system 12 of FIG. 1. The example UI display screen indicates a network address, e.g., a Uniform Resource Locator (URL) or Uniform Resource Identifier (URI) for the merchant enrollment and administration application 28 of FIG. 1.

For the purposes of the present discussion, a UI display screen may be any software-generated depiction presented on a display. Examples of depictions include windows, dialog boxes, displayed tables, and any other graphical UI features, such as UI controls, presented to a user via software, such as a browser. A UI display screen contained within a single border may be called a view or window. Views or windows may include sections, such as sub-views or sub-windows, dialog boxes, graphs, tables, and so on. In certain cases, a UI display screen may refer to all application windows presently displayed on a display.

A UI control may be any displayed element or component of a UI display screen, which is adapted to enable a user to provide input, view data, and/or otherwise interact with a UI. Additional examples of UI controls include buttons, drop down menus, menu items, tap-and-hold functionality, and so on. Similarly, a UI control signal may be any signal that is provided as input for software, wherein the input affects a UI display screen and/or accompanying software application associated with the software.

With reference to FIGS. 1 and 2, the enrollment and administration application 28 of the database system 12 facilitates rendering a merchandise registration section 64. The merchandise registration section 64 includes various UI controls 66, 68, which are adapted to enable a product to be registered and to enable a list of product descriptions and attributes 68 that may be accessed and further configured by a merchant.

The example merchandise registration section 66 includes a gift name field 70, where a merchant may name a product record being created; a price-per-unit field 72 for enabling specification of merchandise price; various check boxes 74 for enabling specification of the merchandise as digital, physical, and/or available worldwide. Note that information specified via the merchandise registration section 66 may represent examples of merchant-specifiable gift attributes.

An additional URL field 76 enables a merchant to provide a URL, i.e., network address to enable the enterprise server system 14 of FIG. 1 to access one or more web services and/or APIs used by the merchant performing the product registration to facilitate processing of an order for one more listed products 68.

After the merchant administrator identifies the merchandise to be usable as a gift via the system 10 of FIG. 1, an add button 78 may be selected. Selection of the add button 78 may result in populating the list 68 with a new entry pertaining to the merchandise specified via the merchandise registration section 66.

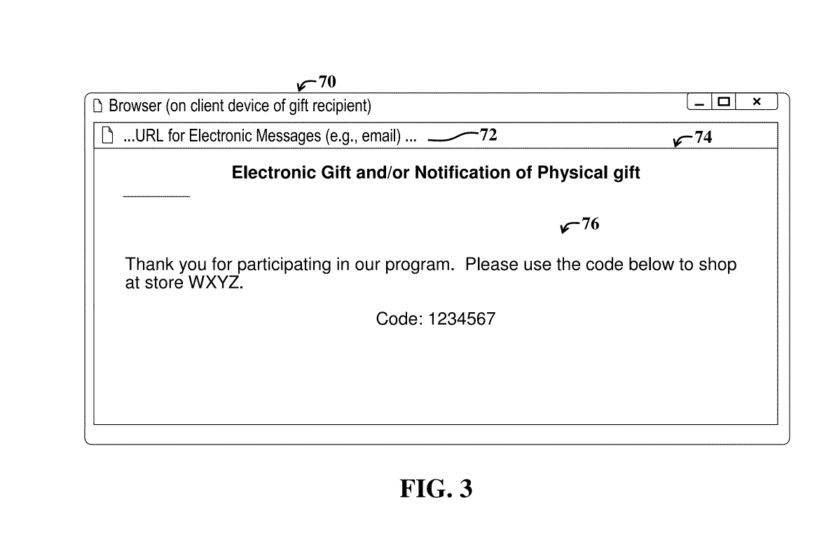

FIG. 3 illustrates a second example UI display screen 70 representing an example electronic gift (or notification thereof) 76 delivered via the system 10 of FIG. 1 to a recipient. In the present example embodiment, the recipient accesses the gift 76 via a URL for retrieving electronic messages (e.g., email or blog) and a browser.

The electronic gift 76 is presented via a browser window 74 and includes a thank you letter and a code, which acts as a gift code for shopping at a particular merchant physical or virtual outlet. Note that the gift 76 may be a hybrid digital gift and physical gift, to the extent that the thank you note and digital code represent electronic forms of gifts, and any item purchased by the gift recipient via the specified code may represent physical gifts. The digital gift 76 may appear in near real time in the recipient's message window 74.

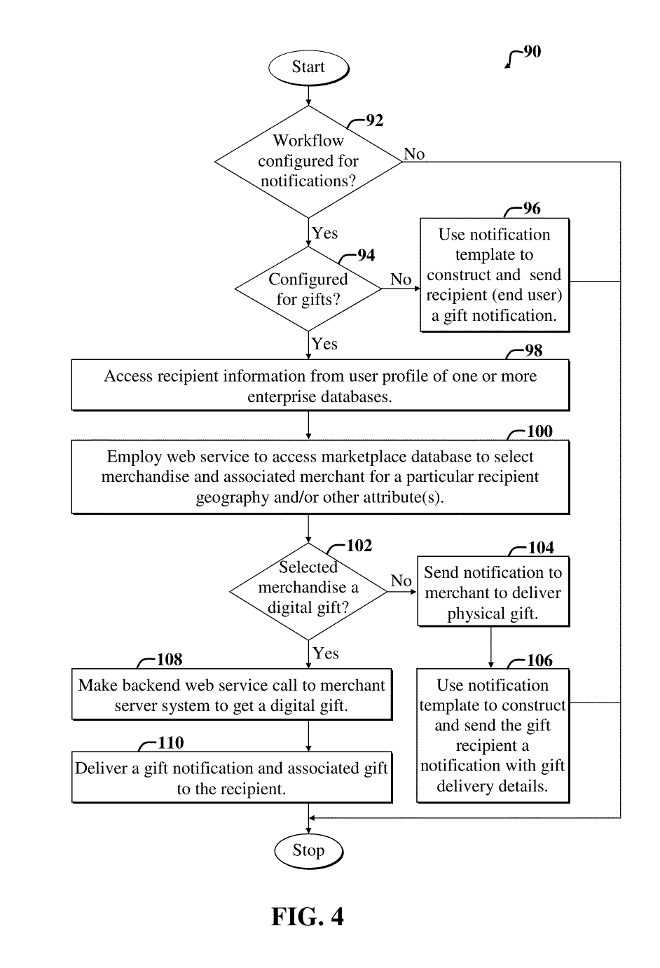

FIG. 4 illustrates a first example process 90 involving gift selection and delivery implementable via the system 10 of FIG. 3. The example process 90 includes an initial workflow-checking step 92, which involves determining whether a current workflow is configured for notifications.

If the workflow is not configured for notifications, then the method 90 ends. Otherwise, a subsequent gift-checking step 94 is performed, whereby the workflow is analyzed to determine if the workflow notifications are configured to handle gift notifications.

If the workflow being analyzed is not configured for gift notifications, then a first notification-template step 96 is performed. The first notification-template step 96 includes using a notification template to construct and sent one or more recipients a gift via a gift notification. The process 90 then completes. Otherwise, if the gift-checking step 94 determines that the workflow being analyzed is configured for gift notifications, then a recipient information step 98 is performed.

The recipient information step 98 includes accessing recipient information from a user profile of one or more enterprise databases (or otherwise obtaining recipient information needed to deliver the gift), such as the ERP applications and databases 40 of FIG. 1.

Subsequently, a first web-service step 100 includes employing a web service to access the marketplace database system 12 of FIG. 1 to select merchandise and an associated pre-approved merchant for a particular recipient location, i.e., geography, and/or other attribute(s).

Next, a digital-checking step 102 is performed, wherein information pertaining to the selected gift is analyzed to determine whether it is a digital gift and/or a physical gift. If the gift is not a digital gift, then a second notification step 104 is performed.

The second notification step 104 includes sending a recipient an electronic message (e.g., to an address specified via the recipient information obtained in step 98) informing the recipient that a physical gift will be sent.

Subsequently, a third notification step 106 is performed, wherein a notification template is used to construct and send the gift recipient a notification with gift delivery details, before the process 90 completes.

If the digital-checking step 102 determines that the selected gift is digital, then the digital gift is retrieved via a backend web service call made in a gift-retrieving step 108. The retrieved digital gift and accompanying notification is then delivered to the recipient in a gift-delivery step 110.

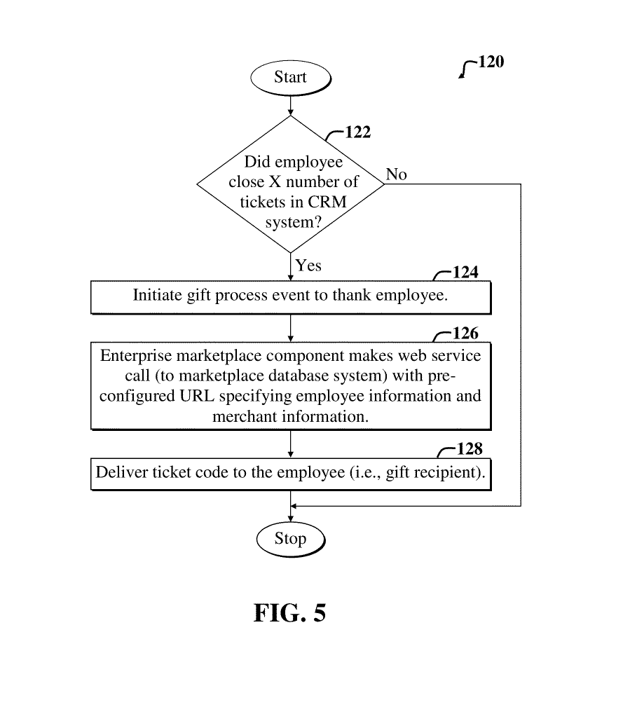

FIG. 5 illustrates a first example event-driven workflow 120 involving delivery of a digital gift to an enterprise employee who has achieved a particular milestone.

The workflow 120 includes detecting an event, e.g., an employee closing X number of tickets in a CRM system, in an event-checking step 122. If the condition pertaining to the event is not fulfilled, then the event has not occurred, and the workflow 120 ends.

Otherwise, a gift-process initiation step 124 is performed. The gift-process initiation step 124 includes initiating a gift process to thank an employee, e.g., via a thank you letter and/or additional gift.

Next, a marketplace-accessing step 126 includes employing an enterprise marketplace component (e.g., the component 30 of FIG. 1) to make one or more web service calls via a pre-configured URL specifying employee information and merchant information. The merchant information may be obtained via the marketplace database 12 of FIG. 1, and the employee information may be obtained from one or more of the ERP applications and databases 40.

Subsequently, a ticket-delivering step 128 includes delivering a ticket code representing the gift to the employee, i.e., gift recipient.

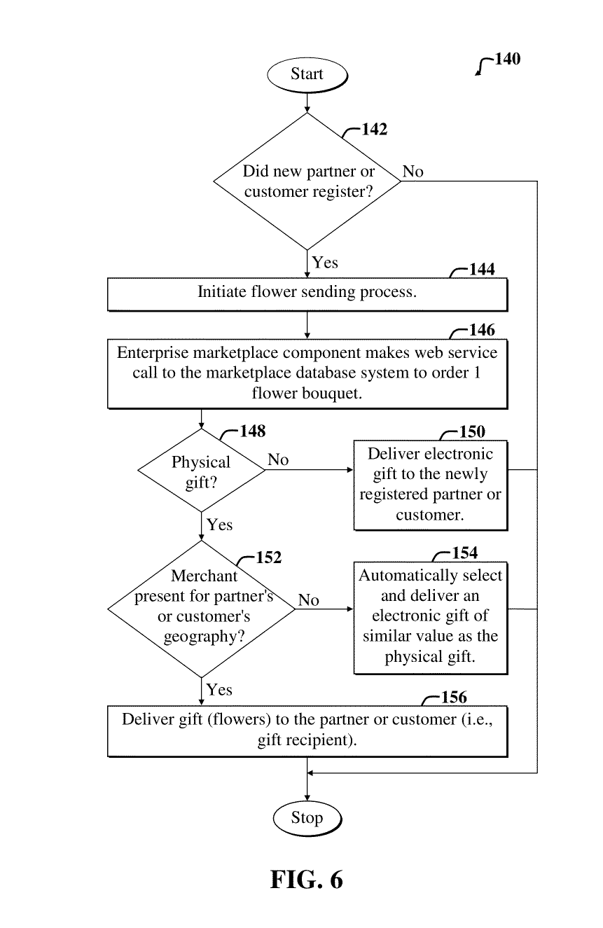

FIG. 6 illustrates a second example event-driven workflow 140 involving delivery of a gift to a newly registered enterprise customer or partner as a reward for registering with the enterprise. An initial event-checking step 142 determines whether the condition and associated event pertaining to registration of a new partner or customer with the enterprise (i.e., proprietor of the enterprise server system 14 of FIG. 1) has occurred.

If the registration event has not occurred, then the workflow 140 completes. Otherwise a flower-sending step 144 initiates a flower sending process.

Next a flower-ordering step 146 is performed. The example flower-ordering step 146 involves the enterprise marketplace component 30 of FIG. 1 making one or more web service calls to the marketplace database system 12 of FIG. 1 to order one flower bouquet.

Next, a physical-checking step 148 determines whether the gift is a physical gift. If not, then a corresponding digital gift is delivered in an electronic-delivery step 150, and the process 140 completes. The delivered gift may include a software generated depiction of flowers, or other digital gift.

Otherwise, if the gift represents a physical gift, e.g., physical flowers, then a subsequent merchant-checking step 152 is performed. The merchant-checking step includes determining if the merchant location is within a predetermined geographical region about the newly registered customer or partner.

Otherwise, then a second digital-gift delivery step 154 is performed before the process 140 completes. The second digital-gift delivery step 154 includes automatically selecting and delivering an electronic gift of similar value as the physical gift, i.e., the flowers.

If the merchant-checking step 152 determines that the merchant is within a geographical region coinciding with the physical address or location of the recipient, then a flower-delivering step 156 is performed. The flower-delivering step 156 includes physically delivering the flowers to the newly registered enterprise partner or customer, i.e., the gift recipient.

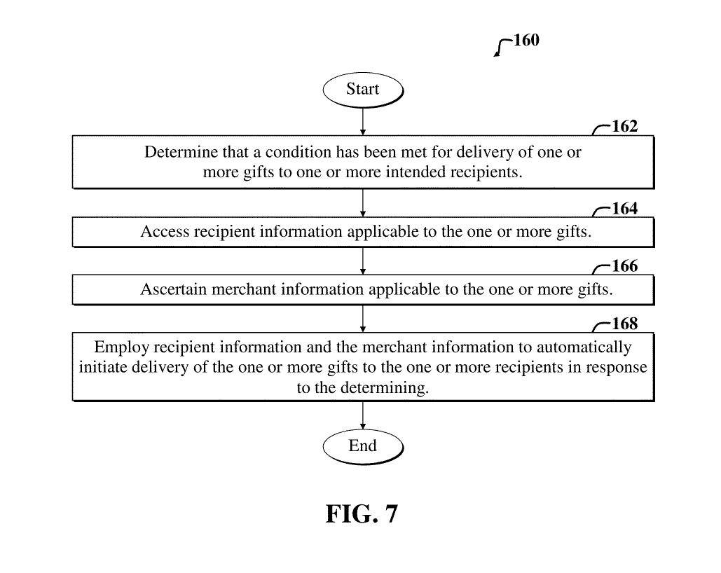

FIG. 7 is a flow diagram of a first example method 160 adapted for use with the embodiments of FIGS. 1-6. The example method 160 is adapted to facilitate selection and delivery of one or more gifts in an enterprise computing environment, and includes a first step 162, which involves determining that a condition has been met (e.g., a particular event has occurred) for delivery of one or more gifts to one or more intended recipients.

A second step 164 includes accessing recipient information pertaining to the one or more intended recipients of the one or more gifts.

A third step 166 includes ascertaining merchant information pertaining to one or more merchants that may produce the one or more gifts.

A fourth step 168 includes employing recipient information and the merchant information to automatically initiate delivery of the one or more gifts to the one or more intended recipients in response to the determining.

Note that the method 160 may be modified, e.g., steps may be added, removed, rearranged, and so on, without departing from the scope of the present teachings. For example, the information pertaining to the one or more intended recipients may include delivery destination information. The delivery destination information may include a physical address for delivery of a physical gift, and wherein the merchant information includes location information pertaining to a location of a merchant that may provide the physical gift.

For the purposes of the present discussion, delivery destination information may be any location information characterizing a physical address, location, or region about an address or location. Delivery may be any conveyance of an item, whether it be electronic and/or physical, from first entity or person (or group of persons) to a second entity or person (or group of persons).

The one or more merchants may include one or more vetted merchants that have been pre-approved by an enterprise employing the method to deliver the one or more gifts. The delivery destination information may include an electronic address for delivery of an electronic gift.

The condition may include occurrence of an event occurring as part of a predetermined enterprise work flow. For example, the event may include an enterprise customer registration for a website or service.

Gift delivery may also include employing a notification service to notifying one or more enterprise customers of a gift given thereto by the enterprise or by one or more enterprise personnel. One or more administrator options may facilitate enabling an administrator to configure the workflow by specifying one or more gifts to be associated with the work flow.

The first step 162 may include monitoring one or more enterprise applications to detect one or more events that meet the condition that warrants delivery of one or more gifts in accordance with a pre-configured workflow.

The first step 162 may further include determining that the condition is applicable to a group of intended recipients, and automatically initiating delivery of one or more gifts to the intended recipients in accordance with recipient information, gift information, and merchant information.

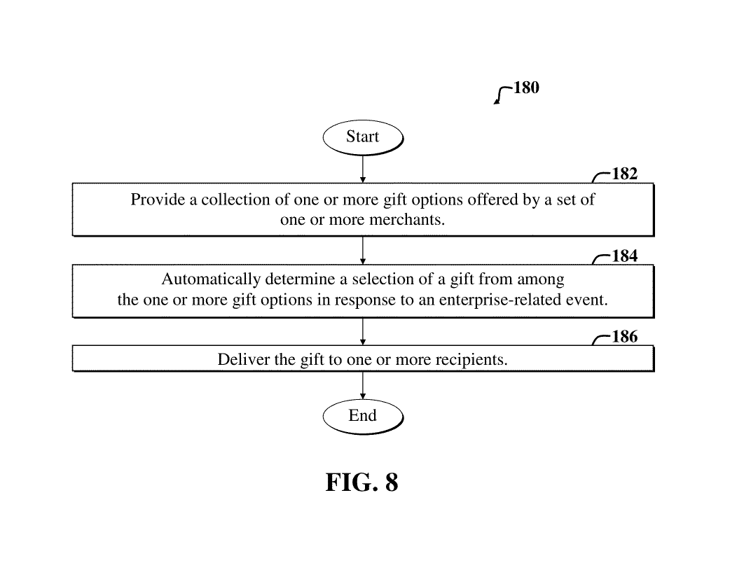

FIG. 8 is a flow diagram of a second example method 180 adapted for use with the embodiments of FIGS. 1-7. The second example method 180 is adapted to facilitate implementing or using an electronic marketplace.

An initial option-providing step 182 includes providing a collection of one or more gift options offered by a set of one or more vendors.

Next, a selecting step 184 includes automatically determining a selection of a gift from among the one or more gift options.

Subsequently, a delivering step 186 includes delivering the gift to one or more recipients.

The example method 180 may be modified without departing from the scope of the present teachings. For example, the option-providing step 182 may further include employing an enterprise application integrated with an enterprise system (or computing environment) to provide access to a collection of indications of the one or more gift options. The enterprise application may include the enterprise application includes and HCM, ERP, CRM, and/or other enterprise applications and/or databases.

The gift selecting step 184 may further include automatically determining a gift in accordance with administrator specified criteria in a workflow. The user or gift recipient may include one or more enterprise personnel.

Although the description has been described with respect to particular embodiments thereof, these particular embodiments are merely illustrative, and not restrictive. For example, while certain embodiments are discussed with respect to enterprise gift-giving tasks, embodiments are not limited thereto. Various organizations, such as schools, governments, and so on, may adapt embodiments discussed herein to enable efficient gift giving, without undue experimentation, and without departing from the scope of the present teachings.

Furthermore, while certain embodiments present an internal gifting system integrated with enterprise applications, embodiments are not limited thereto. For example, a separate web interface to a marketplace database may enable personnel to manually specify rules for dispatching gifts at particular time intervals.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for facilitating selection and delivery of one or more gifts in an enterprise computing environment, the enterprise computing environment including one or more client devices in communication with a server system, wherein the server system executes webpage software, wherein the webpage software provides webpage information accessible to one or more client devices, the server system performing the following acts:
determining that a condition has been met for delivery of one or more gifts to one or more recipients;
accessing recipient information pertaining to the one or more recipients of the one or more gifts;
ascertaining merchant information pertaining to one or more merchants that may produce the one or more gifts; and
using the recipient information and the merchant information to automatically initiate delivery of the one or more gifts to the one or more recipients in response to the determining.

2. The method of claim 1, wherein the information pertaining to the one or more recipients includes delivery destination information.

3. The method of claim 2, wherein the delivery destination information includes a physical address for delivery of a physical gift, and wherein the merchant information includes location information pertaining to a location of a merchant that may provide the physical gift.

4. The method of claim 3, wherein the one or more merchants include one or more vetted merchants, that have been pre-approved by an enterprise employing the method to deliver the one or more gifts.

5. The method of claim 2, wherein the delivery destination information includes an electronic address for delivery of an electronic gift.

6. The method of claim 5, wherein the electronic address includes an email address of a recipient of the electronic gift.

7. The method of claim 5, wherein the electronic address includes a phone number for delivery of a text message.

8. The method of claim 1, wherein the condition includes occurrence of an event occurring as part of a predetermined enterprise work flow.

9. The method of claim 8, wherein the event includes enterprise customer registration for a website or service.

10. The method of claim 9, wherein delivering includes employing a notification service to notifying one or more enterprise customers of a gift given thereto by the enterprise or by one or more enterprise personnel.

11. The method of claim 8, wherein the event includes registration of a partner of an enterprise employing the method.

12. The method of claim 8, further including providing an option for an administrator to configure the work flow by specifying one or more gifts to be associated with the work flow.

13. The method of claim 1, wherein determining further includes monitoring one or more enterprise applications to detect one or more events that meet the condition, wherein the condition represents a condition for initiation of delivery of one or more gifts.

14. The method of claim 13, wherein the one or more enterprise applications include one or more Enterprise Resource Planning (ERP) applications.

15. The method of claim 13, wherein the one or more enterprise applications includes a Human Capital Management (HCM) or Customer Relationship Management (CRM) application.

16. The method of claim 1, wherein employing further includes:
determining whether a gift to be issued is electronic or physical, and, if the gift is electronic then delivering the gift in near real time to one or more recipients, else if the gift is physical then automatically selecting a merchant to facilitate delivery of the gift to a recipient based on a location of the merchant and a location of the recipient.

17. The method of claim 16, further including determining if a merchant for delivering a physical gift is not within a predetermined region that includes a location of the recipient, and then automatically selecting an alternative electronic gift to be delivered to the recipient in place of the physical gift.

18. The method of claim 1, wherein determining includes determining that the condition is applicable to a group of recipients, and automatically initiating delivery of one or more gifts to the recipients in accordance with recipient information, gift information, and merchant information.

19. An apparatus comprising:
a digital processor coupled to a display and to a processor-readable storage device, wherein the processor-readable storage device includes one or more instructions executable by the digital processor to perform the following acts:
determining that a condition has been met for delivery of one or more gifts to one or more recipients;
accessing recipient information pertaining to the one or more recipients of the one or more gifts;
ascertaining merchant information pertaining to one or more merchants that may produce the one or more gifts; and
employing recipient information and the merchant information to automatically initiate delivery of the one or more gifts to the one or more recipients in response to the determining.

20. A processor-readable storage device including instructions executable by a digital processor, the processor-readable storage device including one or more instructions for:
determining that a condition has been met for delivery of one or more gifts to one or more recipients;
accessing recipient information pertaining to the one or more recipients of the one or more gifts;
ascertaining merchant information pertaining to one or more merchants that may produce the one or more gifts; and
employing recipient information and the merchant information to automatically initiate delivery of the one or more gifts to the one or more recipients in response to the determining.
